(19) United States
(12) Patent Application Publication
(10) Pub. No.: US 2025/0145779 A1
(43) Pub. Date: May 8, 2025

(54) PROCESS FOR THE PRODUCTION OF AN ULTRA-HIGH MOLECULAR WEIGHT POLYETHYLENE FILM BY EXTRUSION

(71) Applicant: NOWOFOL Kunststoffprodukte GmbH & Co. KG, Siegsdorf (DE)

(72) Inventors: Michael KIRCHNER, Waging am See (DE); Konstantin LUFT, Vachendorf (DE); Ulrich VON GROSSMANN, Siegsdorf (DE)

(21) Appl. No.: 18/930,145

(22) Filed: Oct. 29, 2024

(30) Foreign Application Priority Data
Nov. 2, 2023 (DE) 10 2023 004 385.0

(51) Int. Cl. C08J 5/18; B29C 48/00; B29C 48/08; B29C 48/88; B29K 23/00; C08F 110/02

(52) U.S. Cl. CPC C08J 5/18; B29C 48/022; C08F 110/02; B29C 48/0018; B29C 48/08; B29C 48/914; B29K 2023/0683; B29K 2995/0082; C08F 2500/01; C08F 2500/07; C08J 2323/06

(57) ABSTRACT

Process for producing a film of an ultra-high-molecular-weight polyethylene (UHMW-PE), comprising the steps of providing a UHMW-PE having a density of more than 0.96 g/cm³ and a molecular weight of between 1×10⁴ g/mol and 10×10⁶ g/mol, extruding the provided UHMW-PE with an extruder configured for high shearing, through a combination of a barrier screw with at least one shearing element and at least one mixing element, to give a film, and passing the extruded film over a chill roll combination, with the extrusion temperature being 170° C. to 300° C. The extruded film may be implemented as cast primary film or as film stretched in machine direction. The stretching increases the strengths in machine direction, expands the thickness spectrum and smooths the surface.

### BACKGROUND OF THE INVENTION

The present invention relates to a process for the production of an ultra-high molecular weight polyethylene film by extrusion.

Ultra-high-molecular-weight polyethylene, referred to hereinafter as UHMW-PE, has a host of advantages over other polyethylenes of lower molecular weight. For instance, articles produced from UHMW-PE have properties such as, for example, very high abrasion and wear resistance, outstanding lubricity properties on the basis of a low coefficient of friction, outstanding impact strength, including in the low-temperature sector, extraordinary chemical resistance, and very good UV and weathering stability. In light of these advantageous properties, UHMW-PE is used in numerous areas of application, such as, for example, for load-bearing components of joint prostheses, vibration damping pads, hydraulic cylinders, sports equipment, slide bearings and slide rails, including in the automotive sector and for specific applications in space travel. For such applications, UHMW-PE has hitherto been processed by compression moulding, RAM extrusion, gel spinning and sintering. One specific field of application for UHMW-PE here embraces films, for example, for hose shrouds in the food industry and for hydraulic hoses, and also for running surfaces of skis.

A particular problem arises here in the context of film production via extrusion, since UHMW-PE has a very high viscosity and hence very low flowability values, identified hereinafter as MFI. For example, LUBMER™ L5000, which is available from Mitsui Chemicals, Inc., has a flowability of only 2 g/10 min (190° C., 10 kg load) and therefore cannot be extruded to films of a usable quality by customary processes for the extrusion of polyethylene films.

This problem has been circumvented to date by first processing the UHMW-PE as starting material, in particular in a powder form, into a moulding, via compression sintering or RAM extrusion, and then peeling films from this moulding by a peeling process. WO 2004 067 118 A1, for example, discloses a two-stage process of this kind. This process for film production, however, is both time-consuming and cost-intensive.

EP 4 001 325 A1 and EP 3 913 015 A1 disclose further specific processes for the extrusion of UHMW-PE, which rely in particular on the use of auxiliaries. The latter publication, for example, discloses a process for producing a microporous polyolefin membrane from a polyolefin resin and a plasticizer under a protective gas atmosphere. Accordingly, a process oil (e.g. petroleum oil) must be added as a plastifying agent to the pulverulent UHMW-PE raw material in order to allow a mixture to be processed using a twin-screw extruder. The stated mixture has a UHMW-PE fraction of only 25%, the balance being HDPE.

EP 4 001 325 A1, conversely, discloses not a UHMW-PE but rather a polymer which only has a density of 0.93-0.96 g/cm³ and a relatively low peak melting temperature (peak 2: 136° C.).

Lastly, WO 2023 114 080 A1 discloses a process for producing UHMWPE films wherein the UHMWPE polymer particles are first mixed with a suitable lubricant (e.g. an isoparaffinic hydrocarbon) in accordance with the general process described in the U.S. Pat. No. 9,926,416 B2.

In the prior art, accordingly, for the extrusion of a film, UHMW-PE is mixed with HDPE of lower density and lower molecular weight, and possibly with paraffin oils or mineral oils as well, in order to be able to produce a paste-like, heterophasic and homogeneously dispersed primary film, which in the further process is converted into a mechanically stable film. After the residues of oil that remain have been separated off or washed out, a microporous film is obtained for use, for example, as a separator film.

In both applications, the oil that is used serves both as a processing assistant in the extrusion and for generating the microporosity, by formation of a heterogeneous phase in the melt, which leaves pores in the film after the residues of oil have been washed out.

A disadvantage of the processes known in the prior art is that a compact film which aside from the customary antioxidants and catalyst residues consists exclusively of UHMW-PE cannot be produced.

### SUMMARY OF THE INVENTION

It is an object of the invention, therefore, to furnish a process which enables direct production of films from UHMW-PE, that can not only be cast but also stretched inline, by means of an extrusion without the circuitous route of the peeling of a pre-produced moulding.

This problem is solved in accordance with the invention by the subject matter of independent Claim 1. Advantageous embodiments are subjects of the dependent claims.

The present invention is based on the general concept of enabling direct extrusion of a pure UHMW-PE to give a film by means of a particular configuration of an extrusion process, in terms both of the mechanical properties and of the parameters of the process, and of stretching this film in machine direction, optionally by means of suitable process parameters.

The particular configuration of the extrusion process is defined by the factors of pressure, temperature and residence time of the melt in the process section, and also, in accordance with the invention, by the shear forces introduced onto the UHMW-PE, which is present in pure form.

The shear forces introduced onto the UHMW-PE produce a self-generated lubricant, i.e. process assistant, owing to the partial breaking of the molecular chains, and this solves the problem of the lack of flowability, enabling continuous extrusion of the pellets for the manufacture of flat films.

An extruder suitable for melting and extruding the UHMW-PE which is present in pure form customarily comprises at least two further zones additionally to the feed zone—the latter zone may also have a grooved design. The feed zone is customarily followed by a melting zone (compression zone) and after that an injection zone.

To obtain a homogeneous melt, the extruder preferably has a length L in the range from 15 to 40 D. D here is the screw diameter. The feed zone preferably has a length in the range from 3 to 6 D—here again, D is the screw diameter. This screw diameter refers to the outer diameter of the screw. The L/D ratio of the extruder screw is preferably between 20 and 40, more preferably between 24 and 36.

The thermal conditioning of the extruder is preferably accomplished such that the mass temperature of the melt at the die exit is in the range between 170° C. and 300° C., preferably between 200° C. and 270° C. For this purpose, there are customarily channels in the extruder through which a thermal conditioning medium can flow. The thermal conditioning medium used may comprise, for example, water, preferably under pressure, or thermal conditioning oils. This type of thermal conditioning is preferably used for the heating/cooling of the feed zone. Furthermore, it is also possible for the extruder to be thermally conditioned by way of electrical heating belts with thermocouples and air-cooling fans, to avoid overheating. An alternative also used for targeted cooling in the individual temperature regulation zones is the injection of water.

The screw may have a constant flight depth and pitch; alternatively, however, it is also possible to use a screw in which the pitch or the flight depth changes. A barrier screw comprises an additional screw flight with lower flight depth and greater pitch, to achieve greater shearing and improved melting performance. In the barrier zone, a distinction is made between the solids channel and the melt channel, with the solids channel having a decreasing pitch depth in the conveying direction. The barrier flight separates the solids channel and the melt channel.

The functional principle, history and properties of modern barrier screw designs have been disclosed for example, in the paper given at the 6th Technical Conference on “Neuigkeiten in der Extrusion” [“Innovations in Extrusion” ], 9-10 May 2001, Suddeutsches Kunststoff-Zentrum, Wurzburg, Germany by Dipl.-Ing. Robert Michels, ETA Kunststofftechnologie GmbH, Troisdorf, Germany.

In accordance with the invention, the extruder is equipped with a barrier screw configured for high shearing, which is introduced in the melting zone by the additional barrier flight and in the further extrusion direction by a shearing element. The melt is homogenized in the mounted mixing element (e.g. pineapple mixer). Accordingly, the screw has an additional barrier flight (2nd flight) further to a customary helical flight that is used, and an optimized mixing element further to a shearing element.

Mixing elements employed with preference are, for example, those in which apertures are formed in the screw flight; alternatively, pins may also be provided in the screw channel, for example; furthermore, it is also possible to form a channel with apertures in the mixing element, directed oppositely to the usual thread direction of the channel. A further possibility is to form toothed discs on the screw or to provide notches in the cylinder and on the screw. Another possibility is the use of so-called Dulmage or Rapra mixing elements. Particularly preferred mixing elements are screws with pins in the screw channel, or elements having a toothed mixing element or pineapple geometry.

Examples of suitable shearing elements include shear torpedoes, Troester shearing components or Maddock shearing components and/or a ring on the screw that generates a hold-up space. Particular preference is given to using a Maddock as the shearing element.

One measure of the shearing generated in the extruder is the shear rate, which depends not only on the screw speed but also on the screw geometry and the integrated elements. Other parameters determining the shearing that is introduced are the flowability of the extruded raw material itself and the extruder temperatures.

To attain the desired shearing conditions, such as velocity, residence time, shear rate, processing temperature of the melt, and so on, the speed of the extruder screw or screws can be selected within a defined range. Generally speaking, the product temperature rises with increasing screw speed, because of the mechanical energy additionally introduced into the system.

The screw speed is dependent in principle on the extruder design and may be, for example, between about 10 and about 200 revolutions per minute (rpm) and in certain cases between about 100 and about 300 rpm. Excessive shearing would in turn cause the material to be degraded during extrusion and would result in a partial loss of the properties specific to UHMW PE.

For a given raw material, the shearing is determined primarily by screw speed and screw geometry. In the region of principal shearing, the solids channel of the barrier, the minimum shear rate is preferably 0.6*n 1/s, and it is preferably 9.4*n 1/s in the actual shearing gap of the shearing element. Higher shear rates have further beneficial consequences for the process, and are preferred accordingly.

The shear rate in the screw region of an extruder may be estimated using the two-plate model (cf. FIG. 5). The velocity of the moving plate, v, is obtained from the screw diameter and the extruder speed as follows:

$$v = \frac{π \cdot D \cdot n}{60}$$

D=cylinder diameter/screw diameter at the flight [mm]
d=screw diameter [mm]
n=extruder speed [1/min]

The shear rate is then obtained as follows:

$${γ}^{′} ( ap ) = \frac{π \cdot D \cdot n}{60 \cdot ( D - d ) / 2} [ 1 / s ]$$

TABLE 1

| | Screw element | |
|---|---|---|
| | Shear rate [1/s] | |
| | Dimensions | |
| | [min/s] | [1/min] |
| Conveying region (ahead of barrier zone) | 0.7 | *n |
| Solids channel (start of barrier zone) | 0.6 | *n |
| Solids channel (end of barrier zone) | 1.0 | *n |
| Solids channel (end of barrier flight) | 2.2 | *n |
| Barrier flight | 9.4 | *n |
| Melt channel (barrier zone) | 0.8 | *n |
| Shearing element/shearing gap (e.g. Maddock) | 9.4 | *n |

Direct extrusion of UHMW-PE in pure form, without the addition of raw materials of lower molecular weight and better flow characteristics or the addition of plasticizer oils, is accomplished in accordance with the invention only through the use of extruders or extruder screws with high shearing. As a result of the high shearing, the fraction of low-viscosity, flowable PE that is needed for extrusion is formed directly within the extrusion process itself, without the need for additives and without damaging or degrading the UHMW-PE in such a way that the specific properties of the material are lost.

In accordance with the invention, the standardized shearing is
between 0.1*n and 15.0*n, preferably between 0.5*n and 12.0*n and more preferably between 0.6*n and 10*n in the region of the barrier zone, and
between 5*n to 15*n, preferably between 7.0*n and 12.0*n and more preferably between 9*n to 10*n in the region of the shearing element (e.g. in the Maddock).

In particular, in the region of principal shearing, the solids channel of the barrier, the minimum shear rate is 0.6*n 1/s, and is 9.4*n 1/s in the actual shearing gap of the shearing element. Higher shear rates may have further beneficial consequences for the process, depending on speed, and are preferred accordingly.

Through the use of a suitable mixing element such as the pineapple mixing element, for example, the high-molecular-weight UHMW-PE is shaped into a homogeneous melt with the more flowable PE of lower molecular weight that is formed in the extrusion.

The invention is illustrated using the implementations below, that only represent examples.

### BRIEF DESCRIPTION OF THE DRAWINGS

FIG. 1 shows an extrusion facility which can be used for performing the process of the present invention. The rolls that are represented (numbers 2 to 6 and 8) may be implemented either as individual rolls or else as roll combinations of two or more rolls. Critical to the fabrication of a film which is also stretched in machine direction is the correct temperature regime in the production process.

In the figure, numerals have the following meanings:
(1) Die with flexible die lip for setting the film thickness by way of the width (horizontal or vertical arrangement and/or any desired angle 0° (present position) to 180°; manual or alternatively automatic thickness setting.
(2) Chill roll, alternatively chill roll combination or calender stack.
(3) Preheating roll or preheating roll combination
(4) Slow-running drawing roll(s)
(5) Fast-running drawing roll(s)
(6) Annealing roll(s)
(7) Thickness measurement (direct coupling to the die in the case of automatic thickness setting)
(8) Chill roll(s)
(9) Winder

FIG. 2 shows a graphical representation of results of the measurement of a stretched film of LUBMER™ L3000 from Mitsui Chemicals Inc. (density 0.969 g/cm³) via differential scanning calorimetry (DSC).

The stretching increases the degree of crystallization of the UHMW PE, leading to a shift in the peak melting temperature (146.8° C.) relative to the initial raw material (139.3° C.), represented in FIG. 4. Owing to processes of continued crystallization in the cooling phase of the DSC measurement, the peak melting temperature of the 2nd heating in FIG. 2, at 140.2° C., is just above the figure for the initial raw material prior to film manufacture.

FIG. 3 shows a graphical representation of results of the measurement of a stretched film of LUBMER™ L5000 from Mitsui Chemicals Inc. (density 0.966 g/cm³) via DSC. Because of the higher molecular weight in comparison to the LUBMER™ L3000, the peak melting temperature is 150.5° C.

FIG. 4 shows a graphical representation of results of the measurement of the LUBMER™ L3000 starting material from Mitsui Chemicals Inc. having a density of 0.969 g/cm³ via DSC.

FIG. 5 shows the two-plate model.

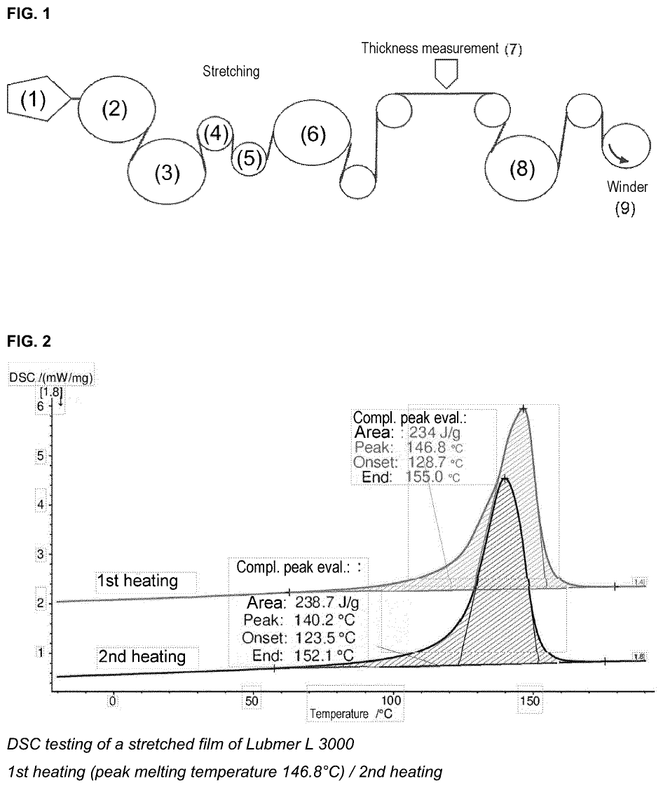

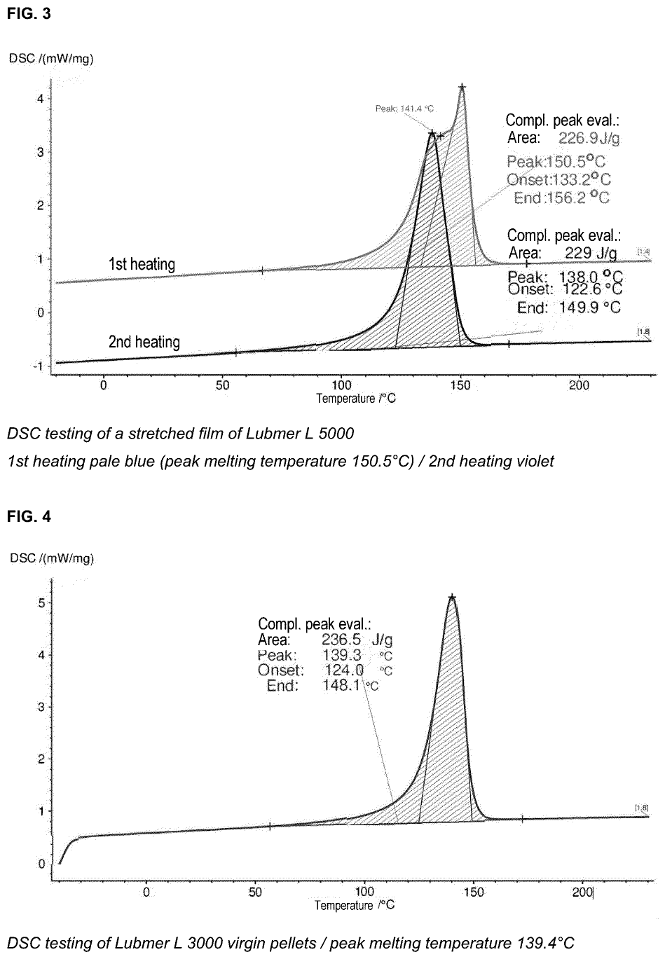

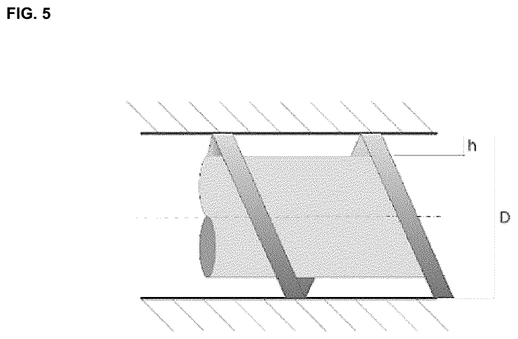

A preferred exemplary embodiment of the invention is illustrated in the description below, with reference to FIGS. 1 to 4.

### DETAILED DESCRIPTION OF THE PREFERRED EMBODIMENTS

An extrusion facility which can be used to perform the process of the present invention is shown schematically in FIG. 1, with only the film die 1 of the extruder being shown, for reasons of simplification. Reference is made to FIG. 1 in the elucidation of the process of the invention that follows.

The process for producing a film of an ultra-high-molecular-weight polyethylene (UHMW-PE) first comprises extruding a UHMW-PE into a film with an extruder configured for high shearing, through combination of a barrier screw having a Maddock shearing component and a pineapple mixer and also an adjustable-thickness film die having a thickness measurement device 1, as shown in FIG. 1.

There are no specific restrictions on the UHMW-PE which can be used in the process of the present invention, and standard commercial materials can be used. Preferably, however, the thermoplastic UHMW-PE that is used has a molecular weight of between 1×10⁴ g/mol and 10×10⁶ g/mol, more preferably between 5×10⁵ g/mol and 5×10⁶ g/mol and more particularly between 0.75×10⁶ g/mol and 3×10⁶ g/mol. The density of the UHMW-PE that is used is more than 0.96 g/cm³. The measurement of density is described in ASTM D 1505.

Especially suitable UHMW-PE grades for usage in the present invention are, for example, LUBMER™ L3000, L4000 or L5000, produced by Mitsui Chemicals, Inc., and mixtures thereof.

The extruder used in the working example of the present invention comprises a combination of a barrier screw having a Maddock shearing component and a pineapple mix, to produce the high shearing of the invention. The extruder with barrier screw has a compression ratio of 1.0 to 1.5, more preferably 1.15 to 1.4, and an L/D ratio of 20 to 40, more preferably 24 to 36. The standardized shearing was between 0.5*n and 12.0*n in the region of the barrier zone, and in the 7.0*n to 12.0*n range in the Maddock shearing component.

The shaping tool for the cast film is a slot die, alternately a T-manifold die or coathanger die, having at least one flexible die lip, via which the thickness tolerance can be set/adapted manually and/or automatically by means of purely mechanical bolts, thermal expansion bolts or piezoelectric actuators.

In accordance with the process of the present invention, the extruded film is passed, in this order in the process, over a chill roll or chill roll combination (2), also referred to as casting unit, at least one preheating roll (3), at least one annealing roll (6), through a thickness gauge (7), at least one chill roll (8) and a take-off unit, not shown, with edge trimming and optionally surface functionalization (e.g. corona pretreatment), to a winding unit (9), the arrangement of which is shown in FIG. 1. Alternatively, edge trimming and thickness measurement are additionally integrated between chill roll(s) and preheating roll(s).

The extrusion temperature, measured ahead of the die, is 170 to 300° C., preferably 190° C. to 280° C., more preferably 200° C. to 270° C.; the temperature of the chill roll or rolls (2) is 20° C. to 150° C., preferably 60° C. to 130° C., more preferably 80° C. to 120° C.; the temperature of the preheating roll or rolls (3) is 60° C. to 130° C., preferably 80° C. to 125° C., more preferably 100° C. to 120° C.; the temperature of the annealing roll or rolls (6) is 80° C. to 160° C., preferably 90° C. to 150° C., more preferably 100° C. to 140° C.; and the temperature of the chill roll or rolls (8) is 0° C. to 50° C., preferably 15° C. to 40° C. The take-off speed of the film is 0.1 to 35 m/min, preferably 2 to 20 m/min and more preferably 3 to 10 m/min.

According to one preferred embodiment of the present process, the extruded film between the preheating roll or rolls (3) and the annealing roll or rolls (6), downstream in this order, is further passed over one or a pair of slow-running stretching rolls (4) and one or a pair of fast-running stretching rolls (5), the arrangement of which is likewise shown in FIG. 1.

According to one preferred embodiment of the present process, the stretching rolls (4) and (5) perform stretching in the machine direction (MD) in the range from 1:3 to 1:8, preferably in the range from 1:3.5 to 1:6.5 and more preferably in the range from 1:4.0 to 1:5.5.

As shown in the examples and in FIGS. 2 and 3, the stretching in the above-stated ranges significantly improves the thermal stability (see FIG. 2, DSC peak melting temperature, 1st heating at 146.8° C. in comparison to the 2nd heating at 140.2° C., and FIG. 4 with a peak melting temperature of 139.3° C.) of the films produced with the process of the invention. In addition, the smoothness of the films is improved and the strengths in machine direction are increased, as well.

According to one preferred embodiment of the present process, the slow-running stretching roll or roll pair (4) has a temperature of 100° C. to 150° C., preferably of 110° C. to 140° C. and more preferably of 120° C. to 135° C., and the fast-running roll or roll pair 5 has a temperature which is higher by 20° C., preferably by 15° C. and more preferably by up to 10° C. than the temperature of the slow-running stretching roll or roll pair (4). The stretching rolls may be arranged either as single rolls or as roll pairs, in which case the temperatures of the individual rolls may be individually varied.

According to one preferred embodiment of the present process, a film thickness uniform over the film width, or the roll profile of the film, is ensured on the winding unit (9) by setting of die bolts of the film die 1 in accordance with a measurement of the thickness using the thickness gauge 7.

According to one preferred embodiment of the present process, an unstretched film has a thickness of more than 60 to 800 micrometres, preferably of 80 to 500 micrometres and more preferably of 100 to 400 micrometres, and a stretched film has a thickness of 10 to 100 micrometres, preferably of 20 to 70 micrometres and more preferably of 30 to 60 micrometres.

According to one preferred embodiment of the present process, an unstretched film has an elasticity modulus in the MD of 800 to 1800 MPa, preferably of 900 to 1600 MPa and more preferably of 1000 to 1400 MPa, and a stretched film has an elasticity modulus in the MD of more than 1800 to 5000 MPa, preferably of 2000 to 4500 MPa and more preferably of 2500 to 4000 MPa.

The present invention further provides an unstretched or stretched film of UHMW-PE which is obtainable by the process of the invention. This film may be used for example, without restriction thereto, as bursting film, as a PFAS-free alternative to fluoropolymer films for low-temperature usage at <−90° C., for example, or as a low-wear sliding layer.

It will be appreciated that the features stated above and those still to be elucidated below may be used not only in the particular specified combination but also in different combinations, or on their own, without departing from the scope of the present invention.

### EXAMPLES

Specified below are examples which are intended to provide further elucidation of the present invention. The present invention is not restricted by these examples.

### Example 1—Production of an Unstretched Film Having a Thickness of 100 μm, Starting from a UHMW-PE Having a Density of 0.966 g/cm³ (Raw Material)

The extrusion took place with a single-screw extruder configured for high shearing, through combination of a barrier screw with a Maddock shearing component and a pineapple mixer. The shear rate corresponded to the standardized shear rates indicated in Table 1, for a screw speed of 17 rpm. The slot die used had a die-gap adjustment range of 0.1 to 1.5 mm and 24 bolts. The exit width was 620 mm. The primary film was cast onto a chill roll having a diameter of 490 mm. The primary film was fixed alternately with an air knife (in-house construction) or electrostatic pinning. The thickness measurement unit came from the company Electronic SYSTEMS and the thickness was measured contactlessly (Kr isotope).

The process conditions were as follows:
extruder temperatures: 200-275° C.
adapter and die temperatures: all zones 250° C.
chill roll temperature (casting roll): 105° C.
chill roll ahead of the winding unit: 20° C.
extruder screw speed: 17 rpm
take-off speed 6.9 m/min

The tests on the films from Table 2 (see E2) took place according to the following standards:
tensile testing (instrument: Zwick): DIN EN ISO 527
film thickness: DIN 53370
surface weight: DIN EN ISO 536
shrinkage (accessory: oven or water bath): DIN EN ISO 11501
friction coeffizient (instrument: Zwick): DIN EN ISO 8295

### Example 2—Production of a Stretched Film Having a Thickness of 41 μm, Starting from a UHMW-PE Having a Density of 0.966 g/cm³ (Raw Material)

The extrusion took place with a single-screw extruder configured for high shearing, through combination of a barrier screw with a Maddock shearing component and a toothed mixing element. The shear rate corresponded to the standardized shear rates indicated in Table 1, for a screw speed of 25 rpm. The slot die used had a die-gap adjustment range of 0.1 to 1.5 mm and 24 bolts. The exit width was 620 mm. The primary film was cast onto a chill roll having a diameter of 490 mm. The primary film was fixed alternately with an air knife (in-house construction) or electrostatic pinning. The thickness measurement unit came from the company Electronic SYSTEMS and the thickness was measured contactlessly (Kr isotope).

The process conditions were as follows:
extruder temperatures: 200 to 270° C.
adapter and die temperatures: all zones 250° C.
chill roll temperature (casting roll): 100° C.
preheating roll temperature: 123° C.
drawing rolls (slow): 124° C.
drawing rolls (fast): 132° C.
continued-heating roll: 120° C.
chill roll ahead of the winding unit: 20° C.
extruder screw speed: 25 rpm
take-off speed 3.7 m/min
winding speed 19.3 m/min

The tests on the films from Table 4 (see E4) took place according to the following standards:
tensile testing (instrument: Zwick): DIN EN ISO 527
film thickness: DIN 53370
surface weight: DIN EN ISO 536
shrinkage (accessory: oven or water bath): DIN EN ISO 11501
friction coeffizient (instrument: Zwick): DIN EN ISO 8295
tensile-impact measurement (Zwick pendulum impact unit): DIN EN ISO

The outstanding properties of the stretched UHMW PE film according to Example 2 are the aforementioned increase in the peak melting temperature and the extremely low shrinkage. For comparable films produced from regular HDPE, the shrinkage is 1.0-2.0%.

Owing to the orientation of the long molecular chains parallel to one another in machine direction, brought about by the stretching, longitudinal stretched UHMW PE films have little cross-linking transverse to the machine direction. As a direct consequence, the film ruptures with a machine-direction crack profile under even low compressive loading. The pressures is required in this case are comparatively low and can be adjusted, by way of the film thickness and the draw ratio, specifically to bursting pressure values <100 kPa. Measurements on stretched PE films produced values as follows:

The table below (Tab. 2) shows the bursting pressure of HDPE and UHMW-PE in comparison

| Film | HDPE | HDPE | UHMW PE | UHMW PE |
|---|---|---|---|---|
| Thickness [μm] | 15 | 30 | 35 | 50 |
| Bursting | 77 | 168 | 29 | 71 |
| pressure [kPa] | | | | |

The table below (Tab. 3) shows the results of the above examples:

| | | | Unstretched | Stretched |
|---|---|---|---|---|
| | | | Lubmer L 5000 | Lubmer L 5000 |
| | Test | | film (density | film (density |
| Testing criterion | direction | Units | 0.966) | 0.966) |
| Thickness (gauge) | TD | μm | 100 | 41 |
| Surface weight | | g/m² | 74 | 34 |
| Elasticity modulus | MD | MPa | 1070 | 3495 |
| Stretching force | MD | N/15 mm | 43 | 72.2 |
| Stretching elongation | MD | % | 24.9 | 12.2 |
| Force at 5% elongation | MD | N/15 mm | — | 48.5 |
| Force at 10% elongation | MD | N/15 mm | — | 69.7 |
| Force at 20% elongation | MD | N/15 mm | — | 83.8 |
| Max. Tensile force | MD | N/15 mm | 43.99 | 91.9 |
| Elongation at break | | % | 36.9 | 27.4 |
| Tensile impact | TD | kJ/m² | 76.8 | 210.4 |
| Shrinkage 100° C./5 min | MD | % | 1 | 0 |
| Static friction coefficient | MD a-a | | 0.2 | 0.21 |
| Sliding friction coefficient | MD a-a | | 0.21 | 0.22 |
| Static friction coefficient | MD i-i | | 0.22 | 0.21 |
| Sliding friction coefficient | MD i-i | | 0.22 | 0.22 |

The process of the invention therefore enables direct production of UHMW-PE films which can be both unstretched and stretched and which have excellent properties, by means of extrusion, without the circuitous route of peeling of a pre-produced moulding.

1. A process for producing a film of an ultra-high-molecular-weight polyethylene (UHMW-PE), comprising the steps of:
providing a UHMW-PE having a density of more than 0.96 g/cm³ and a molecular weight of between 1×10⁴ g/mol and 10×10⁶ g/mol
extruding the provided UHMW-PE with an extruder configured for high shearing, through a combination of a barrier screw with at least one shearing element and at least one mixing element, to give a film,
passing the extruded film over a chill roll combination, with the extrusion temperature being 170° C. to 300° C.

2. The process according to claim 1, wherein a standardized shearing is between 0.1*n and 15*n in the region of the barrier zone and between 5*n to 15*n in the region of the shearing element.

3. The process according to claim 1, wherein an extruder with barrier screw having a compression ratio of 1.0 to 1.5 and an L/D ratio of 20 to 40.

4. The process according to claim 1 wherein the screw speed is between 15 and about 150 rpm.

5. The process according to claim 1, wherein the chill roll or chill roll combination (2) comprises, in this order in the process, at least one preheating roll (3), at least one annealing roll (6), a thickness gauge (7), at least one further chill roll (8), a take-off unit with edge trimming and optionally surface functionalization, and a winding unit (9), and in that the temperature of the chill roll or rolls (2) directly after a die (1) is 20° C. to 150° C., the temperature of the preheating roll or rolls (3) is 60° C. to 130° C., the temperature of the annealing roll or rolls (6) is 80° C. to 160° C. and the temperature of the chill roll or rolls (8) is 0° C. to 50° C., and in that the take-off speed of the film from the film die (1) is 0.1 to 35 m/min.

6. The process according to claim 5, wherein the extruded film between the preheating roll or rolls (3) and the annealing roll or rolls (6), in this order in the process, is further passed over one or a pair of slow-running stretching rolls (4) and one or a pair of fast-running stretching rolls (5).

7. The process according to claim 6, wherein the slow-running stretching roll or rolls (4) have a temperature of 100° C. to 150° C. and the fast-running stretching roll or rolls (5) have a temperature which is higher by up to 20° C. than the temperature of the slow-running stretching roll or rolls (4).

8. The process according to claim 6, wherein the stretching roll units (4) and (5) perform stretching in the machine direction (MD) in the range from 1:3 to 1:8.

9. The process according to claim 1, wherein an unstretched film has a thickness of more than 60 to 800 micrometres and/or an elasticity modulus in the MD of 800 to 1800 MPa.

10. The process according to claim 6, wherein a stretched film has a thickness of 10 to 100 micrometres and/or an elasticity modulus in the MD of more than 1800 to 5000 MPa.

11. An unstretched or stretched film of UHMW-PE, obtainable by the process according to claim 1.

12. A use of an unstretched or stretched film according to claim 11 as bursting film, as a PFAS-free alternative to fluoropolymer films for low-temperature usage at <−90° C. or as a low-wear, PFAS-free sliding layer.

13. A use of a stretched film according to claim 6 as bursting film having a decidedly low bursting pressure which is consistent over the film width and running length and is <100 kPa.

14. A use according to claim 13, wherein the bursting pressure for a film thickness s 40 μm is <50 kPa.
